(19) United States
(12) Patent Application Publication
(10) Pub. No.: US 2025/0309328 A1
(43) Pub. Date: Oct. 2, 2025

(54) ALL-SOLID-STATE BATTERY AND METHOD OF MANUFACTURING ALL-SOLID-STATE BATTERY

(71) Applicant: HONDA MOTOR CO., LTD., Tokyo (JP)

(72) Inventors: Kosuke TATSUSHIMA, Saitama (JP); Shoji TAKAHASHI, Saitama (JP); Hiroyoshi TSUDA, Saitama (JP); Masanari HIGUCHI, Saitama (JP)

(21) Appl. No.: 19/055,459

(22) Filed: Feb. 17, 2025

(30) Foreign Application Priority Data
Mar. 26, 2024 (JP) 2024-048969

(51) Int. Cl. H01M 10/04; H01M 10/0562; H01M 10/058

(52) U.S. Cl. CPC H01M 10/0481; H01M 10/0562; H01M 10/058; H01M 2300/0068; H01M 2300/0094

(57) ABSTRACT

To provide an all-solid-state battery having a multilayered solid electrolyte layer structure, capable of improving battery performance by enhancing interface bondability. In an all-solid-state battery, a positive electrode layer and a negative electrode layer are stacked with solid electrolyte layers interposed therebetween. The all-solid-state battery includes: a first solid electrolyte layer pressure-bonded to the positive electrode layer; a third solid electrolyte layer pressure-bonded to the negative electrode layer; and a second solid electrolyte layer that bonds the first solid electrolyte layer and the third solid electrolyte layer. The particle diameter of the solid electrolyte particles constituting the second solid electrolyte layer is smaller than the particle diameter of the solid electrolyte particles constituting the first solid electrolyte layer and the third solid electrolyte layer, respectively.

This application is based on and claims the benefit of priority from Japanese Patent Application No. 2024-048969, filed on 26 Mar. 2024, the content of which is incorporated herein by reference.

### BACKGROUND OF THE INVENTION

### Field of the Invention

The present invention relates to an all-solid-state battery and a method of manufacturing an all-solid-state battery.

### Related Art

In recent years, research and development have been conducted on secondary batteries that contribute to energy efficiency, in order to enable more people to secure access to affordable, reliable, sustainable, and advanced energy. Among secondary batteries, all-solid-state batteries using a solid electrolyte as the electrolyte are particularly notable and excellent for the safety due to the nonflammable nature of solid electrolytes, and for the higher energy density. An all-solid-state battery configuration has been studied that involves a laminated structure in which a plurality of positive electrode layers and negative electrode layers are alternately stacked with solid electrolyte layers interposed therebetween (see, for example, U.S. Published Patent Application Publication, No. 2022/158226, Specification).

On the other hand, a multilayered (two-layered) structure for solid electrolyte layers within all-solid-state batteries has been proposed (see, for example, PCT International Publication No. WO 2014/010043).

Patent Document 1: U.S. Published Patent Application Publication, No. 2022/158226, Specification

Patent Document 2: PCT International Publication No. WO 2014/010043

### SUMMARY OF THE INVENTION

The technology disclosed in PCT International Publication No. WO 2014/010043 primarily concerns a method of creating a two-layered structure for the solid electrolyte layer. However, in cases where the solid electrolyte layer is multilayered, a technology to ensure interface bondability and improve battery performance including battery capacity and cycle characteristics has not been sufficiently examined as the current situation. For example, in order to enhance the density of each layer, it is conceivable to pressure-bond the positive electrode layer and the solid electrolyte layer in advance; however, as a result of such pressure bonding, the surface of the solid electrolyte layer tends to become flattened, which may impair the bondability to other layers. Accordingly, there has been a need for a technology to establish the solid electrolyte layer in multiple layers, while ensuring the bondability of each layer constituting an all-solid-state battery.

The present invention has been made in view of the above, and aims to provide an all-solid-state battery capable of improving battery performance by enhancing interface bondability in an all-solid-state battery that includes a multilayered solid electrolyte layer.
(1) An all-solid-state battery, in which a positive electrode layer and a negative electrode layer are stacked with solid electrolyte layers interposed therebetween, the all-solid-state battery including: a first solid electrolyte layer pressure-bonded to the positive electrode layer; a third solid electrolyte layer pressure-bonded to the negative electrode layer; and a second solid electrolyte layer that bonds the first solid electrolyte layer and the third solid electrolyte layer, in which a particle diameter of solid electrolyte particles constituting the second solid electrolyte layer is smaller than a particle diameter of solid electrolyte particles constituting the first solid electrolyte layer and the third solid electrolyte layer.

According to the invention as described in (1), an all-solid-state battery capable of improving battery performance can be provided by enhancing interface bondability.
(2) In the all-solid-state battery as described in (1), materials constituting the first solid electrolyte layer, the second solid electrolyte layer, and the third solid electrolyte layer are the same.

According to the invention as described in (2), interface bondability can be more favorably improved.
(3) In the all-solid-state battery as described in (1) or (2), an interface between the second solid electrolyte layer and each of the first and third solid electrolyte layers penetrates to a side of the first solid electrolyte layer and to a side of the third solid electrolyte layer, respectively.

According to the invention as described in (3), interface bondability can be more favorably improved.
(4) In the all-solid-state battery as described in any one of (1) to (3), a particle diameter D50 of the solid electrolyte particles constituting the second solid electrolyte layer is ½ or less relative to a particle diameter D50 of the solid electrolyte particles constituting the first solid electrolyte layer and a particle diameter D50 of the solid electrolyte particles constituting the third solid electrolyte layer.

According to the invention as described in (4), interface bondability can be more favorably improved.
(5) In the all-solid-state battery as described in any one of (1) to (4), materials constituting the first solid electrolyte layer, the second solid electrolyte layer, and the third solid electrolyte layer include a sulfide-based solid electrolyte and at least any one of a polyvinylidene fluoride-based binder and a styrene-butadiene-based binder, a particle diameter D10 of the solid electrolyte particles constituting the first solid electrolyte layer and the third solid electrolyte layer is 0.3 to 0.5 μm, the particle diameter D50 thereof is from 0.5 to 1.0 μm, and a particle diameter D95 thereof is from 1.5 to 2.0 μm, and the particle diameter D50 of the solid electrolyte particles constituting the second solid electrolyte layer is from 0.2 to 0.3 μm.

According to the invention as described in (5), interface bondability can be more favorably improved.
(6) In the all-solid-state battery as described in any one of (1) to (5), the second solid electrolyte layer includes solid electrolyte particles and a base material, and a diameter of the base material is smaller than the particle diameter of the solid electrolyte particles.

According to the invention as described in (6), interface bondability can be more favorably improved.
(7) An all-solid-state battery, in which a positive electrode layer and a negative electrode layer are stacked with solid electrolyte layers interposed therebetween, the all-solid-state battery including: a first solid electrolyte layer pressure-bonded to the positive electrode layer; a third solid electrolyte layer arranged on a side of the negative electrode; and
   a second solid electrolyte layer that bonds the first solid electrolyte layer and the third solid electrolyte layer, in which a particle diameter of solid electrolyte particles constituting the second solid electrolyte layer is smaller than a particle diameter of solid electrolyte particles constituting the first solid electrolyte layer and the third solid electrolyte layer.

According to the invention as described in (7), an all-solid-state battery capable of improving battery performance can be provided by enhancing interface bondability.
(8) In the all-solid-state battery as described in any one of (1) to (7), one other layer is arranged between the negative electrode layer and the third solid electrolyte layer, and the third solid electrolyte layer is bonded to the other layer.

According to the invention as described in (8), interface bondability can be more favorably improved.
(9) A method of manufacturing an all-solid-state battery, in which a positive electrode layer and a negative electrode layer are stacked with solid electrolyte layers interposed therebetween, the method including the steps of: forming a first laminate by pressure-bonding a layer including the positive electrode layer and a first solid electrolyte layer; forming a second laminate by pressure-bonding a layer including the negative electrode layer and a third solid electrolyte layer; forming a second solid electrolyte layer by arranging unpressurized solid electrolyte particles between the first solid electrolyte layer and the third solid electrolyte layer; and pressure-bonding the first laminate and the second laminate via the second solid electrolyte layer, in which a particle diameter of the solid electrolyte particles constituting the second solid electrolyte layer is smaller than a particle diameter of the solid electrolyte particles constituting the first electrolyte layer and the third solid electrolyte layer.

According to the invention as described in (9), an all-solid-state battery capable of improving battery performance can be manufactured by enhancing interface bondability.
(10) In the method of manufacturing an all-solid-state battery as described in (9), materials constituting the first solid electrolyte layer, the second solid electrolyte layer, and the third solid electrolyte layer are the same.

According to the invention as described in (10), interface bondability can be more favorably improved.
(11) In the method of manufacturing an all-solid-state battery as described in (9) or (10), after pressure-bonding the first laminate and the second laminate via the second solid electrolyte layer, an interface between the second solid electrolyte layer and each of the first and third solid electrolyte layers penetrates to a side of the first solid electrolyte layer and to a side of the third solid electrolyte layer, respectively.

According to the invention as described in (11), interface bondability can be more favorably improved.
(12) In the method of manufacturing an all-solid-state battery as described in any one of (9) to (11), a particle diameter D50 of the solid electrolyte particles constituting the second solid electrolyte layer is ½ or less relative to a particle diameter D50 of the solid electrolyte particles constituting the first solid electrolyte layer and a particle diameter D50 of the solid electrolyte particles constituting the third solid electrolyte layer.

According to the invention as described in (12), interface bondability can be more favorably improved.
(13) In the method of manufacturing an all-solid-state battery as described in any one of (9) to (12), materials constituting the first solid electrolyte layer, the second solid electrolyte layer, and the third solid electrolyte layer include a sulfide-based solid electrolyte and at least any one of a polyvinylidene fluoride-based binder and a styrene-butadiene-based binder, the particle diameter D10 of the solid electrolyte particles constituting the first solid electrolyte layer and the third solid electrolyte layer is 0.4 μm, the particle diameter D50 thereof is 0.7 μm, and the particle diameter D95 thereof is 1.7 μm, and the particle diameter D50 of the solid electrolyte particles constituting the second solid electrolyte layer is 0.2 μm.

According to the invention as described in (13), interface bondability can be more favorably improved.
(14) In the method of manufacturing an all-solid-state battery as described in any one of (9) to (13), the second solid electrolyte layer includes solid electrolyte particles and a base material, and a diameter of the base material is smaller than the particle diameter of the solid electrolyte particles.

According to the invention as described in (14), interface bondability can be more favorably improved.
(15) A method of manufacturing an all-solid-state battery, in which a positive electrode layer and a negative electrode layer are stacked with solid electrolyte layers interposed therebetween, the method including the steps of: forming a first laminate by pressure-bonding a layer including the positive electrode layer and a first solid electrolyte layer; manufacturing a second laminate by arranging a third solid electrolyte layer on a side of the negative electrode layer; forming a second solid electrolyte layer by arranging unpressurized solid electrolyte particles between the first solid electrolyte layer and the third solid electrolyte layer; and pressure-bonding the first laminate and the second laminate via the second solid electrolyte layer, in which a particle diameter of the solid electrolyte particles constituting the second solid electrolyte layer is smaller than a particle diameter of the solid electrolyte particles constituting the first electrolyte layer and the third solid electrolyte layer, respectively.

According to the invention as described in (15), an all-solid-state battery capable of improving battery performance can be manufactured by enhancing interface bondability.
(16) The method of manufacturing an all-solid-state battery as described in any one of (9) to (15), further includes a step of arranging one other layer between the negative electrode layer and the third solid electrolyte layer, in which the third solid electrolyte layer is bonded to the other layer.

According to the invention as described in (16), interface bondability can be further favorably improved.

### BRIEF DESCRIPTION OF THE DRAWINGS

FIG. 1 is a schematic cross-sectional view illustrating an all-solid-state battery according to an embodiment of the present invention;

FIG. 2 is a schematic cross-sectional view illustrating the interface of a solid electrolyte layer according to an embodiment of the present invention; and

FIG. 3 is a schematic cross-sectional view illustrating the interface of a solid electrolyte layer according to another embodiment.

### DETAILED DESCRIPTION OF THE INVENTION

### All-Solid-State Battery

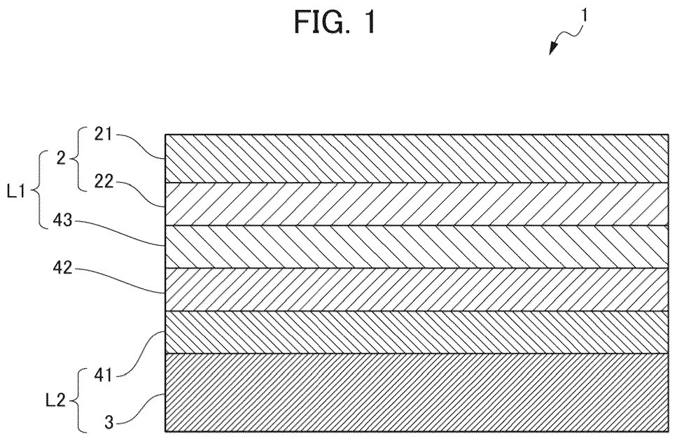

In an all-solid-state battery 1, a positive electrode layer and a negative electrode layer are stacked with solid electrolyte layers interposed therebetween. As illustrated in FIG. 1, the all-solid-state battery 1 includes an electrode laminate, in which a negative electrode layer 2, solid electrolyte layers 41, 42, and 43, and a positive electrode layer 3 are sequentially stacked in this order. The structure of the all-solid-state battery 1 is not limited to this configuration, and the negative electrode layer 2 and the positive electrode layer 3 only need to be stacked with three solid electrolyte layers 41, 42, and 43 interposed therebetween, and the number of layers is not particularly limited.

The solid electrolyte layers of the all-solid-state battery 1 include a first solid electrolyte layer 41 arranged on the positive electrode layer 3 side, a third solid electrolyte layer 43 arranged on the negative electrode layer 2 side, and a second solid electrolyte layer 42 interposed between the first solid electrolyte layer 41 and the third solid electrolyte layer 43. Optionally, another layer, such as an intermediate layer, may be interposed between the negative electrode layer 2 and the third solid electrolyte layer 43.

The all-solid-state battery 1 is not particularly limited in type, but may be a lithium-ion solid secondary battery or a lithium-metal secondary battery.

### Negative Electrode Layer

The negative electrode layer 2 includes a negative electrode active material layer 22 and a negative electrode current collector layer 21. The negative electrode active material layer 22 is not particularly limited, and may be composed of materials that can be used as the negative electrode active materials of a solid battery. Examples of the negative electrode active material layer 22 include a lithium metal layer. The lithium metal may include a lithium alloy, in addition to a lithium metal simple substance. Other examples of materials that may compose the negative electrode active material layer 22 include silicon-based active materials such as Si and Si alloys, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, as well as metal indium.

The negative electrode active material layer 22 may also contain additional materials that may be included in the negative electrode active material layer of a solid-state battery. Examples of such materials include solid electrolytes, conductive auxiliary agent, and binders. Examples of the solid electrolyte include materials similar to those contained in the solid electrolyte layer described later. Examples of the conductive auxiliary agent include carbon black, natural graphite, carbon fiber, carbon nanotubes, and the like. Examples of the binder include nitrile-based binders, polyester-based binders, acrylic acid-based binders, cellulose-based binders, styrene-based binders, styrene-butadiene-based binders, vinyl acetate-based binders, urethane-based binders, fluoroethylene-based binders, polyvinylidene fluoride-based binders, and others.

The negative electrode current collector layer 21 is not particularly limited and may be composed of materials such as copper, nickel, or stainless steel. Examples of the configurations of the negative electrode current collector layer 21 include, for example, foil, plate, mesh, nonwoven fabric, and foam forms. A portion of the negative electrode current collector layer 21 extends in a predetermined direction to form a negative electrode current collector tab.

### Positive Electrode Layer

The positive electrode layer 3 includes a positive electrode active material layer and a positive electrode current collector layer. The positive electrode active material layer is not particularly limited, and may be composed of materials that can be used as the positive electrode active material of a solid-state battery. Examples of the positive electrode active material constituting the positive electrode active material layer 31 include layered positive electrode active material particles such as of LiCoO₂, LiNiO₂, LiCoₓNi_{y}Mn_{z}O₂ (where x+y+z=1), LiVO₂, LiCrO₂; spinel-type positive electrode active materials such as of LiMn₂O₄, Li(Ni_{0.25}Mn_{0.75})₂O₄, LiCoMnO₄, Li₂NiMn₃O₈; olivine-type positive electrode active materials such as of LiCoPO₄, LiMnPO₄, LiFePO₄; solid solution oxides such as of Li₂MnO₃—LiMO₂ (M=Co, Ni, etc.); conductive polymers such as polyaniline and polypyrrole; sulfides such as Li₂S, CuS, Li—Cu—S compounds, TiS₂, FeS, MoS₂, and Li—Mo—S compounds; and mixtures of sulfur and carbon. The positive electrode active material may be composed of a single one of the above materials or a combination of two or more of the above materials.

The positive electrode current collector layer is not particularly limited and may be composed of materials such as aluminum, stainless steel, or conductive carbon (such as graphite or carbon nanotubes). The configuration of the positive electrode current collector layer may include, for example, foil, plate, mesh, nonwoven fabric, and foam forms. A portion of the positive electrode current collector layer extends in a predetermined direction to form a positive electrode current collector tab.

### Solid Electrolyte Layer

The solid electrolyte layers 41, 42, and 43 are formed between the negative electrode layer 2 and the positive electrode layer 3. In the present embodiment, the first solid electrolyte layer 41 arranged on the positive electrode layer side, the second solid electrolyte layer 42, and the third solid electrolyte layer 43 arranged on the negative electrode layer side are sequentially stacked in this order. The first solid electrolyte layer 41 is pressure-bonded to the positive electrode layer 3, while the third solid electrolyte layer 43 is pressure-bonded to the negative electrode layer 2. The second solid electrolyte layer 42 serves as a layer that bonds the first solid electrolyte layer 41 and the third solid electrolyte layer 43.

The first solid electrolyte layer 41 is pressure-bonded to the positive electrode layer 3. Accordingly, the interface on the second solid electrolyte layer 42 side of the first solid electrolyte layer 41 is compressed into a substantially flat state (only unevenness corresponding to the particle diameter of the solid electrolyte particles is present).

The solid electrolyte material constituting the first solid electrolyte layer 41 is not particularly limited, and only needs to be a material that can be used as an electrolyte of a solid-state battery. Examples include inorganic solid electrolytes, such as sulfide-based solid electrolytes, oxide-based solid electrolytes, halide-based solid electrolytes, and lithium-containing salts, as well as polymer-based solid electrolytes such as polyethylene oxide. Particularly, sulfide-based solid electrolytes are preferably used. A single type of the solid electrolyte may be used, or a combination of two or more types may be used.

The solid electrolyte material constituting the first solid electrolyte layer 41 is in particle form. The particle diameter D10 (median diameter) of the solid electrolyte particles constituting the first solid electrolyte layer 41 is preferably from 0.3 μm to 0.5 μm. The particle diameter D50 (median diameter) is preferably from 0.5 μm to 1.0 μm. The particle diameter D95 (median diameter) is preferably from 1.5 um to 2.0 μm.

The first solid electrolyte layer 41 may also contain materials that can be used in the solid electrolyte layer of a solid-state battery, other than the solid electrolyte material. For example, the first solid electrolyte layer 41 may contain a binder. Examples of binders include nitrile-based binders, polyester-based binders, acrylic acid-based binders, cellulose-based binders, styrene-based binders, styrene-butadiene-based binders, vinyl acetate-based binders, urethane-based binders, fluoroethylene-based binders, and polyvinylidene fluoride-based binders. Particularly, the layer preferably contains at least either of a polyvinylidene fluoride-based binder and a styrene-butadiene-based binder.

The third solid electrolyte layer 43 is arranged on the negative electrode layer 2 side. The third solid electrolyte layer 43 may be pressure-bonded to the negative electrode layer 2. In cases where an intermediate layer is provided between the negative electrode layer 2 and the third solid electrolyte layer 43, the third solid electrolyte layer 43 may be pressure-bonded to the negative electrode layer 2 via the intermediate layer. The configuration of the third solid electrolyte layer 43 other than the above may be the same as the configuration of the first solid electrolyte layer 41.

The intermediate layer is arranged between the negative electrode layer 2 and the third solid electrolyte layer 43. For example, in cases where the all-solid-state battery 1 is a lithium-metal battery, the intermediate layer serves the function of uniformly depositing lithium metal. Consequently, the interface between the intermediate layer and the third solid electrolyte layer 43 is stabilized. In a case where the all-solid-state battery 1 is a lithium-metal secondary battery that includes an intermediate layer, the all-solid-state battery 1 may be an anode-free battery in which the negative electrode active material layer 22 is absent during initial charging. In this case, a lithium metal layer functioning as the negative electrode active material layer 22 is formed after the initial charge-discharge cycle.

The material constituting the intermediate layer is not particularly limited, and may include, for example, metals capable of alloying with lithium, or amorphous carbon. The metals capable of alloying with lithium include, for example, tin (Sn), silicon (Si), zinc (Zn), magnesium (Mg), gold (Au), platinum (Pt), palladium (Pd), silver (Ag), aluminum (Al), bismuth (Bi), and antimony (Sb). These metals capable of alloying with lithium may be in nanoparticle form. Examples of amorphous carbon include, for example, types of carbon black such as acetylene black, furnace black, and Ketjen black, as well as coke and activated carbon. The amorphous carbon may be graphitizable carbon (soft carbon), non-graphitizable carbon (hard carbon), CNT (carbon nanotube), fullerene, or graphene. The intermediate layer may also include a binder in addition to the above materials.

The second solid electrolyte layer 42 bonds the first solid electrolyte layer 41 and the third solid electrolyte layer 43. The particle diameter (for example, median diameter D50) of the solid electrolyte particles constituting the second solid electrolyte layer 42 is smaller than the particle diameter of the solid electrolyte particles constituting the first solid electrolyte layer 41 and the third solid electrolyte layer 43. As a result, the particles constituting the second solid electrolyte layer 42 penetrate into the interfaces between the first solid electrolyte layer 41 and the third solid electrolyte layer 43, and thus can achieve favorable bondability. A description will be provided below with reference to the drawings.

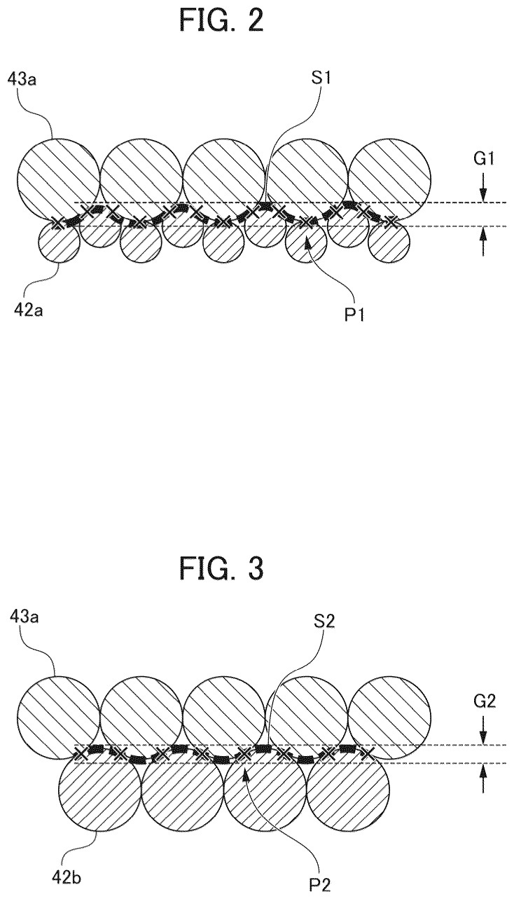

FIG. 2 is a diagram schematically illustrating the interface between the second solid electrolyte layer 42 and the third solid electrolyte layer 43. In FIG. 2, the solid electrolyte particles 42a constituting the second solid electrolyte layer 42 are smaller than the solid electrolyte particles 43a constituting the third solid electrolyte layer 43. In the example illustrated in FIG. 2, the particle diameter of the solid electrolyte particles 42a is ½ or less of the particle diameter of the solid electrolyte particles 43a.

In contrast, FIG. 3 illustrates an example in which the particle diameter of the solid electrolyte particles 42b constituting the second solid electrolyte layer 42 is approximately the same as the particle diameter of the solid electrolyte particles 43a constituting the third solid electrolyte layer 43. When comparing FIG. 2 and FIG. 3, two solid electrolyte particles 42b contact one solid electrolyte particle 43a at contact points P2 in FIG. 3; whereas, three solid electrolyte particles 42a contact one solid electrolyte particle 43a at contact points P1 in FIG. 2. That is, the number of contact points can be increased by 1.5 times by setting the particle diameter of the solid electrolyte particles 42a to ½ or less of the particle diameter of the solid electrolyte particles 43a. Furthermore, in the example in FIG. 2, as compared with the example in FIG. 3, the interface bonding area S1 is larger than S2. This configuration can improve the bondability between the second solid electrolyte layer 42 and the third solid electrolyte layer 43.

As illustrated in FIG. 2, the solid electrolyte particles 42a constituting the second solid electrolyte layer 42 penetrate into the interface side of the third solid electrolyte layer 43. Specifically, in the configuration illustrated in FIG. 2, as compared with the example illustrated in FIG. 3, the penetration depth G1 is increased by approximately 40% relative to the penetration depth G2, and the interface bonding line length increases by approximately 5%. As illustrated in FIGS. 2 and 3, the term “penetration depth” refers to the difference (gap) between the average of the deepest positions to which each solid electrolyte particle 42a, located at the interface with the third solid electrolyte layer 43 penetrates to the third solid electrolyte layer 43 side, and the average of the deepest positions to which each solid electrolyte particle 43a penetrates to the second solid electrolyte layer 42 side. The term “interface bonding line length” refers to the length of the interface bonding area S1 or S2, as viewed in the cross-sections illustrated in FIGS. 2 and 3. The configuration as illustrated in FIG. 2 can improve the bondability between the second solid electrolyte layer 42 and the third solid electrolyte layer 43.

In order to achieve the beneficial effect of improving the bondability, the particle diameter D50 (median diameter) of the solid electrolyte particles constituting the second solid electrolyte layer 42 is preferably from 0.2 μm to 0.3 μm.

The second solid electrolyte layer 42 may also contain a base material that can be filled with the solid electrolyte. Although the base material is not particularly limited, a nonwoven fabric is one example. In cases where the second solid electrolyte layer 42 includes a base material, the diameter (fiber diameter) of the base material is preferably smaller than the particle diameter of the solid electrolyte particles constituting the second solid electrolyte layer 42.

FIGS. 2 and 3 illustrate the example of the interface between the second solid electrolyte layer 42 and the third solid electrolyte layer 43; however, the same applies to the interface between the second solid electrolyte layer 42 and the first solid electrolyte layer 41.

In the present embodiment, the solid electrolyte materials constituting the first solid electrolyte layer 41, the second solid electrolyte layer 42, and the third solid electrolyte layer 43 are the same. As a result, the bondability between each layer can be further improved. Note that the type and content of the binder may vary, and the presence or absence of a base material may vary.

### Method of Manufacturing All-Solid-State Battery

The method of manufacturing the all-solid-state battery according to the present embodiment includes: a first pressure-bonding step of manufacturing a first laminate L1 by pressure-bonding layers including the positive electrode layer 3 and the first solid electrolyte layer 41; a step of manufacturing a second laminate L2 by arranging the third solid electrolyte layer 43 on the negative electrode layer 2 side; a step of forming the second solid electrolyte layer 42 by arranging unpressurized solid electrolyte particles between the first solid electrolyte layer 41 and the third solid electrolyte layer 43; and a third pressure-bonding step of pressure-bonding the first laminate L1 and the second laminate L2 via the second solid electrolyte layer 42.

The first pressure-bonding step is a step of pressure-bonding layers including the positive electrode active material layer side of the positive electrode layer 3 and the first solid electrolyte layer 41. The pressing pressure in the first pressure-bonding step may be, for example, from 600 MPa to 1200 MPa.

The step of arranging the third solid electrolyte layer 43 on the negative electrode layer 2 side may be a second pressure-bonding step of manufacturing the second laminate L2 by pressure-bonding layers including the negative electrode layer 2 and the third solid electrolyte layer 43. Another layer, such as an intermediate layer, may also be interposed between the negative electrode layer 2 and the third solid electrolyte layer 43. The pressing pressure in the second pressure-bonding step may be, for example, from 300 MPa to 800 MPa.

The step of forming the second solid electrolyte layer 42 is a step of arranging unpressurized solid electrolyte particles between the first solid electrolyte layer 41 of the first laminate L1 and the third solid electrolyte layer 43 of the second laminate L2, which are obtained as described above. The unpressurized solid electrolyte particles may be made into a mixture by adding the materials constituting the second solid electrolyte layer such as the base material and binder thereto.

In the step of forming the second solid electrolyte layer 42, the solid electrolyte particles to be arranged are maintained unpressurized, thereby allowing unevenness exceeding the particle diameter of the solid electrolyte particles to exist on the surface. The Young's modulus also remains low due to the unpressurized state.

In the third pressure-bonding step, the first laminate L1 and the second laminate L2 are bonded. The pressing pressure in the third pressure-bonding step may be, for example, from 300 MPa to 800 MPa.

As described above, the particle diameter of the solid electrolyte particles constituting the second solid electrolyte layer 42 is smaller than the particle diameter of the solid electrolyte particles constituting the first solid electrolyte layer 41 and the third solid electrolyte layer 43. Therefore, the particles can penetrate the interface, thereby improving the interface bondability. Even when the pressing pressure is reduced in the third pressure-bonding step, the second solid electrolyte layer 42 can be densified, i.e., the resistance can be reduced.

While preferred embodiments of the present invention have been described above, the present invention is not limited to these embodiments. The all-solid-state battery 1 may adopt a configuration suitable for use in a solid-state battery with an exterior body, in addition to the laminated structure illustrated in FIG. 1.

### EXPLANATION OF REFERENCE NUMERALS

1: all-solid-state battery (laminated structure of all-solid-state battery)
2: negative electrode layer
3: positive electrode layer
41: first solid electrolyte layer
42: second solid electrolyte layer
43: third solid electrolyte layer
L1: first laminate
L2: second laminate

What is claimed is:

1. An all-solid-state battery, in which a positive electrode layer and a negative electrode layer are stacked with solid electrolyte layers interposed therebetween, the all-solid-state battery comprising:
a first solid electrolyte layer pressure-bonded to the positive electrode layer;
a third solid electrolyte layer pressure-bonded to the negative electrode layer; and
a second solid electrolyte layer that bonds the first solid electrolyte layer and the third solid electrolyte layer, wherein
a particle diameter of solid electrolyte particles constituting the second solid electrolyte layer is smaller than a particle diameter of solid electrolyte particles constituting the first solid electrolyte layer and the third solid electrolyte layer.

2. The all-solid-state battery according to claim 1, wherein materials constituting the first solid electrolyte layer, the second solid electrolyte layer, and the third solid electrolyte layer are the same.

3. The all-solid-state battery according to claim 1, wherein interfaces of the second solid electrolyte layer with the first solid electrolyte layer and with the third solid electrolyte layer respectively penetrate to a side of the first solid electrolyte layer and to a side of the third solid electrode layer.

4. The all-solid-state battery according to claim 1, wherein a particle diameter D50 of the solid electrolyte particles constituting the second solid electrolyte layer is ½ or less relative to a particle diameter D50 of the solid electrolyte particles constituting the first solid electrolyte layer and a particle diameter D50 of the solid electrolyte particles constituting the third solid electrolyte layer.

5. The all-solid-state battery according to claim 4, wherein
materials constituting the first solid electrolyte layer, the second solid electrolyte layer, and the third solid electrolyte layer include a sulfide-based solid electrolyte and at least any one of a polyvinylidene fluoride-based binder and a styrene-butadiene-based binder,
a particle diameter D10 of the solid electrolyte particles constituting the first solid electrolyte layer and the third solid electrolyte layer is 0.3 to 0.5 μm, the particle diameter D50 thereof is from 0.5 to 1.0 μm, and a particle diameter D95 thereof is from 1.5 to 2.0 μm, and
the particle diameter D50 of the solid electrolyte particles constituting the second solid electrolyte layer is from 0.2 to 0.3 μm.

6. The all-solid-state battery according to claim 1, wherein
the second solid electrolyte layer includes solid electrolyte particles and a base material, and
a diameter of the base material is smaller than the particle diameter of the solid electrolyte particles.

7. An all-solid-state battery, in which a positive electrode layer and a negative electrode layer are stacked with solid electrolyte layers interposed therebetween, the all-solid-state battery comprising:
a first solid electrolyte layer pressure-bonded to the positive electrode layer;
a third solid electrolyte layer arranged on a side of the negative electrode layer; and
a second solid electrolyte layer that bonds the first solid electrolyte layer and the third solid electrolyte layer, wherein
a particle diameter of solid electrolyte particles constituting the second solid electrolyte layer is smaller than a particle diameter of solid electrolyte particles constituting the first solid electrolyte layer and the third solid electrolyte layer.

8. The all-solid-state battery according to claim 1, wherein
one other layer is arranged between the negative electrode layer and the third solid electrolyte layer, and
the third solid electrolyte layer is bonded to the one other layer.

9. A method of manufacturing an all-solid-state battery, in which a positive electrode layer and a negative electrode layer are stacked with solid electrolyte layers interposed therebetween, the method comprising the steps of:
forming a first laminate by pressure-bonding layers including the positive electrode layer and a first solid electrolyte layer;
forming a second laminate by pressure-bonding layers including the negative electrode layer and a third solid electrolyte layer;
forming a second solid electrolyte layer by arranging unpressurized solid electrolyte particles between the first solid electrolyte layer and the third solid electrolyte layer; and
pressure-bonding the first laminate and the second laminate via the second solid electrolyte layer, wherein
a particle diameter of the solid electrolyte particles constituting the second solid electrolyte layer is smaller than a particle diameter of the solid electrolyte particles constituting the first electrolyte layer and the third solid electrolyte layer.

10. The method of manufacturing an all-solid-state battery according to claim 9, wherein materials constituting the first solid electrolyte layer, the second solid electrolyte layer, and the third solid electrolyte layer are the same.

11. The method of manufacturing an all-solid-state battery according to claim 9, wherein, after pressure-bonding the first laminate and the second laminate via the second solid electrolyte layer, interfaces of the second solid electrolyte layer with the first solid electrolyte layer and with the third solid electrolyte layer respectively penetrate to a side of the first solid electrolyte layer and to a side of the third solid electrode layer.

12. The method of manufacturing an all-solid-state battery according to claim 9, wherein a particle diameter D50 of the solid electrolyte particles constituting the second solid electrolyte layer is ½ or less relative to a particle diameter D50 of the solid electrolyte particles constituting the first solid electrolyte layer and a particle diameter D50 of the solid electrolyte particles constituting the third solid electrolyte layer.

13. The method of manufacturing an all-solid-state battery according to claim 12, wherein
materials constituting the first solid electrolyte layer, the second solid electrolyte layer, and the third solid electrolyte layer include a sulfide-based solid electrolyte and at least any one of a polyvinylidene fluoride-based binder and a styrene-butadiene-based binder,
a particle diameter D10 of the solid electrolyte particles constituting the first solid electrolyte layer and the third solid electrolyte layer is 0.4 μm, a particle diameter D50 thereof is 0.7 μm, and a particle diameter D95 thereof is 1.7 μm, and
a particle diameter D50 of the solid electrolyte particles constituting the second solid electrolyte layer is 0.2 μm.

14. The method of manufacturing an all-solid-state battery according to claim 9, wherein
the second solid electrolyte layer includes solid electrolyte particles and a base material, and
a diameter of the base material is smaller than the particle diameter of the solid electrolyte particles.

15. A method of manufacturing an all-solid-state battery, in which a positive electrode layer and a negative electrode layer are stacked with solid electrolyte layers interposed therebetween, the method comprising the steps of:
forming a first laminate by pressure-bonding layers including the positive electrode layer and a first solid electrolyte layer;
manufacturing a second laminate by arranging a third solid electrolyte layer on a side of the negative electrode layer;
forming a second solid electrolyte layer by arranging unpressurized solid electrolyte particles between the first solid electrolyte layer and the third solid electrolyte layer; and
pressure-bonding the first laminate and the second laminate via the second solid electrolyte layer, wherein
a particle diameter of the solid electrolyte particles constituting the second solid electrolyte layer is smaller than a particle diameter of the solid electrolyte particles constituting the first electrolyte layer and the third solid electrolyte layer, respectively.

16. The method of manufacturing an all-solid-state battery according to claim 9, further comprising a step of arranging one other layer between the negative electrode layer and the third solid electrolyte layer, wherein
the third solid electrolyte layer is bonded to the other layer.
